(19) United States
(12) Patent Application Publication
(10) Pub. No.: US 2009/0136843 A1
(43) Pub. Date: May 28, 2009

(54) HERMETICALLY SEALED BATTERY, BATTERY PACK USING THE HERMETICALLY SEALED BATTERY, AND ELECTRONIC APPARATUS EQUIPPED WITH THE BATTERY PACK

(76) Inventors: Hiroshi Yamamoto, Osaka (JP); Osamu Watanabe, Osaka (JP); Fusaji Kita, Osaka (JP)

Correspondence Address: BIRCH STEWART KOLASCH & BIRCH, PO BOX 747, FALLS CHURCH, VA, 22040-0747, US

(21) Appl. No.: 12/323,262

(22) Filed: Nov. 25, 2008

(30) Foreign Application Priority Data
Nov. 26, 2007 (JP) 2007-304787

(51) Int. Cl. H01M 2/30; H01M 2/08

(52) U.S. Cl. 429/179; 429/185

(57) ABSTRACT

A hermetically sealed battery including a liquid injection hole provided in a battery case and a seal that blocks the liquid injection hole, the liquid injection hole being sealed with the seal by welding the seal to a portion around the liquid injection hole in a state in which an electrolyte solution is injected into the battery case. The seal is formed of a metal body in which an aluminum layer formed of aluminum or an aluminum alloy and a dissimilar metal layer formed of a metal different from aluminum or an alloy of the metal are joined one on top of the other. A lead that is connected to a PTC element or a protection circuit is joined to the metal body. The joining strength between the lead and the metal body is less than the joining strength between the seal and the portion around the liquid injection hole.

### BACKGROUND OF THE INVENTION

1. Field of the Invention

The present invention relates to a hermetically sealed battery such as a lithium ion battery, a battery pack using the hermetically sealed battery, and an electronic apparatus equipped with the battery pack.

2. Description of Related Art

JP 2002-373642A (FIGS. 1 and 2), JP 2003-317703A (FIGS. 1 to 3), and JP 2006-12829A (FIGS. 2a and 3) disclose a hermetically sealed battery in which an electrode body, an electrolyte solution, and so on are contained in a battery can, and an upper surface opening of the battery can is blocked with a lid to form a battery case. In this hermetically sealed battery, the electrolyte solution is injected into the battery can through a liquid injection hole provided in the lid, the liquid injection hole is then blocked with a seal formed of a sealing stopper, a plate, or the like, and thereafter the seal is welded to the upper surface of the lid, which forms a peripheral edge portion of the liquid injection hole, using a laser or the like, thereby sealing the liquid injection hole with the seal.

Such a hermetically sealed battery is adapted to be installed in an external apparatus, such as a mobile telephone or a notebook personal computer, as a power supply. A lead connected to a protection circuit or the like is welded to the seal. This lead is formed of nickel or the like having, for example, excellent corrosion resistance, whereas the battery can and the lid are formed of aluminum or an aluminum alloy.

Therefore, the seal is preferably formed of aluminum or an aluminum alloy in light of welding compatibility with the lid. However, aluminum or an aluminum alloy has poor welding compatibility with nickel.

In other words, when the lead is welded to a seal formed of aluminum or an aluminum alloy, welding defects, such as void spaces (voids), occur within a bead and lead to a decrease in the weld strength.

To address this problem, as shown in JP 2002-373642A, JP 2003-317703A, and JP 2006-12829A, the seal is formed of a clad material in which a nickel layer made of nickel or a nickel alloy is joined to the upper side of an aluminum layer made of aluminum or an aluminum alloy. Then, the aluminum layer side is welded to the lid, and the lead is welded to the upper surface of the nickel layer.

In order to improve the reliability of the hermetically sealed battery, the battery pack, and the electronic apparatus using the hermetically sealed battery and the battery pack, a design that prevents a phenomenon such as liquid leakage from easily occurring even under an external force is necessary. Laser welding using a YAG laser or the like enables the seal to be easily welded even when the seal is disposed in a narrow space, and so the seal is laser-welded to the lid.

However, in JP 2002-373642A, JP 2003-317703A, and JP 2006-12829A, since the upper surface of the aluminum layer of the seal is entirely covered with the nickel layer, a laser beam is irradiated from above the nickel layer (see FIG. 2 of JP 2002-373642A and FIG. 3 of JP 2006-12829A).

In this case, in a weld portion, while the aluminum layer of the seal melts, the nickel layer of the seal also melts. Thus, there is a problem in that welding defects, such as void spaces, occur within a bead and lead to a decrease in the weld strength.

With such decreased weld strength, when a lead connected to a PTC (Positive Temperature Coefficient) element or a protection circuit is joined to the clad material forming the seal and an external force is applied to the lead, there is a risk that the seal may be dislodged and liquid leakage may occur.

### SUMMARY OF THE INVENTION

The present invention has been conceived to address the conventional problems as described above, and it is an object thereof to provide a hermetically sealed battery with reduced risk of liquid leakage by considering the balance between the weld strength between the battery case and the seal and the weld strength between the seal and the lead, a battery pack using the hermetically sealed battery, and an electronic apparatus equipped with the battery pack.

In order to achieve this object, the hermetically sealed battery of the present invention is a hermetically sealed battery in which a liquid injection hole provided in a battery case and through which an electrolyte solution is injected is blocked with a seal, and the seal is welded to a portion around the liquid injection hole, thereby sealing the liquid injection hole with the seal, wherein the seal is formed of a metal body in which an aluminum layer formed of aluminum or an aluminum alloy and a dissimilar metal layer formed of a metal different from aluminum or an alloy of the metal are joined one on top of the other; a lead that is connected to a PTC or a protection circuit is joined to the metal body; and the joining strength between the lead and the metal body is less than the joining strength between the seal and the portion around the liquid injection hole.

The battery pack of the present invention is a battery pack provided with the hermetically sealed battery, wherein the lead is joined to a positive electrode terminal and a protection circuit; and a second lead is joined to the opposite side of the protection circuit from a portion joined to the lead, the second lead being joined to a negative electrode terminal via a PTC element.

The electronic apparatus of the present invention is an electronic apparatus equipped with a battery pack provided with a hermetically sealed battery, wherein the hermetically sealed battery includes a liquid injection hole provided in a battery case and a seal that blocks the liquid injection hole, the liquid injection hole being sealed with the seal by welding the seal to a portion around the liquid injection hole in a state in which an electrolyte solution is injected into the battery case, and wherein the seal is formed of a metal body in which an aluminum layer formed of aluminum or an aluminum alloy and a dissimilar metal layer formed of a metal different from aluminum or an alloy of the metal are joined one on top of the other; a lead connected to a PTC element or a protection circuit is joined to the metal body; and the joining strength between the lead and the metal body is less than the joining strength between the seal and the portion around the liquid injection hole.

### BRIEF DESCRIPTION OF THE DRAWINGS

FIG. 1 is a vertical sectional front view of a hermetically sealed battery according to an embodiment of the present invention.

FIG. 2 is an exploded perspective view of the hermetically sealed battery according to the embodiment of the present invention.

FIG. 3 is an exploded perspective view of an example of a battery pack according to the embodiment of the present invention.

FIG. 4 is an exploded view of another example of the battery pack according to the embodiment of the present invention.

FIG. 5 is a plan view showing a state in which a seal and a lead are connected to each other according to another embodiment of the present invention.

FIG. 6 is a perspective view showing a state in which various components have been attached from the state of FIG. 5.

FIG. 7 is a vertical sectional front view showing an example of the completed battery pack according to the embodiment of the present invention.

FIG. 8 is a diagram showing how a battery can according to the embodiment of the present invention is covered with a label.

### DETAILED DESCRIPTION OF THE INVENTION

According to the hermetically sealed battery of the present invention, the joining strength between the lead and the metal body is less than the joining strength between the seal and the portion around the liquid injection hole. Therefore, even in the case where an external force is applied to the lead, dislodgement of the seal and resultant liquid leakage can be prevented.

In the hermetically sealed battery of the present invention, it is preferable that the seal is a positive electrode terminal.

Moreover, it is preferable that the aluminum layer of the metal body is disposed on the battery case side, and a peripheral edge portion of the aluminum layer protrudes outside the seal beyond a peripheral edge of the dissimilar metal layer; and the peripheral edge portion of the aluminum layer is welded to the portion around the liquid injection hole. With this configuration, only the peripheral edge portion of the aluminum layer can be easily welded to the portion around the liquid injection hole in the battery case using a laser or the like. In other words, the dissimilar metal layer of the seal can be prevented from melting with the aluminum layer during welding, and the occurrence of welding defects due to melting of both of the aluminum layer and the dissimilar layer can be prevented, and thus the decrease in the weld strength can be prevented.

Moreover, it is preferable that the seal has a head section that is welded to the portion around the liquid injection hole and a shaft section that projects downward from a lower surface of the head section; the shaft section of the seal is inserted in the liquid injection hole; and the head section of the seal is formed of the metal body in which the dissimilar metal layer is joined to the upper side of the aluminum layer. With this configuration, after the shaft section of the seal is inserted into the liquid injection hole, the seal is reliably positioned in the battery case by the shaft section. Therefore, the liquid injection hole can be reliably blocked with the seal, and in addition, the seal can be reliably welded to the portion around the liquid injection hole even when an automatic welder is used. Moreover, since the shaft section is inserted into the liquid injection hole, the liquid injection hole can be more reliably sealed with the seal.

Moreover, it is preferable that the shaft section of the seal is formed integrally with the aluminum layer in the head section. This configuration facilitates production of the seal having the shaft section.

Moreover, it is preferable that the peripheral edge portion of the aluminum layer protrudes outside the seal beyond the peripheral edge of the dissimilar metal layer by a protruding dimension of 0.1 mm or more. With this configuration, the weld portion can be prevented from easily reaching the dissimilar metal layer.

Moreover, it is preferable that an exterior side of the battery case is formed of aluminum or an aluminum alloy. With this configuration, the welding compatibility between the aluminum layer of the seal and the battery case can be improved.

Moreover, it is preferable that the peripheral edge portion of the aluminum layer is welded to the portion around the liquid injection hole using a laser.

In the battery pack of the present invention, it is preferable that the lead extends toward the negative electrode terminal while having an upwardly bent portion, has a portion that extends in a thickness direction of the hermetically sealed battery and is bent over, or has a portion that extends away from the negative electrode terminal and is bent over. With this configuration, the space retaining accuracy of the protection circuit is easily secured.

Moreover, it is preferable that the lead has the upwardly bent portion at a position on the positive electrode terminal or within 5 mm from an end of the positive electrode terminal. This configuration is advantageous for securing the positioning accuracy of the protection circuit.

Moreover, it is preferable that the protection circuit is positioned above the negative electrode terminal; the second lead extends away from the positive electrode terminal or has a portion that extends in a thickness direction of the hermetically sealed battery and is bent over; and an insulating portion made of resin is provided between the protection circuit and the negative electrode terminal positioned under the protection circuit.

Moreover, it is preferable that the seal is covered with resin to form a resin portion, and a boundary portion between the hermetically sealed battery and the resin portion is covered with a label. With this configuration, the battery can can be reliably covered with the label, and this is advantageous for improving the insulation quality.

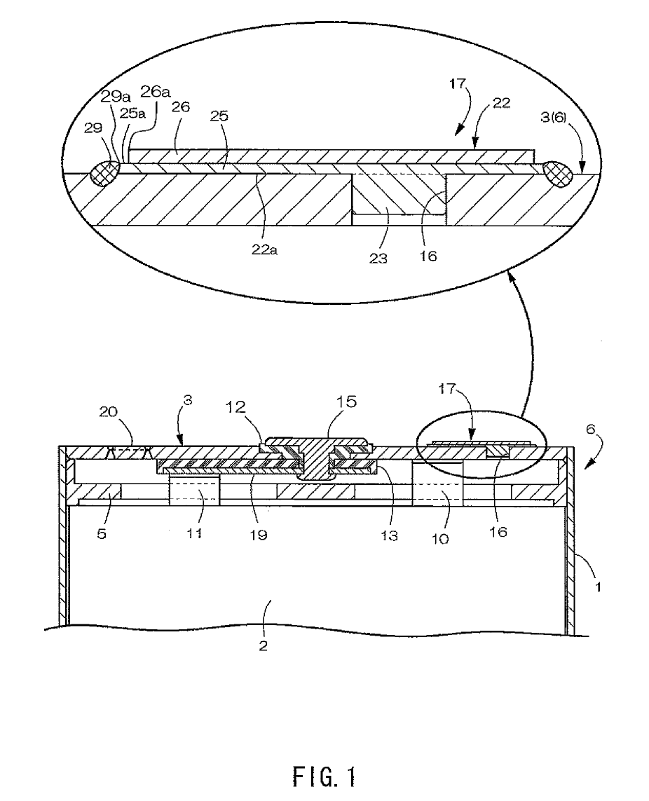

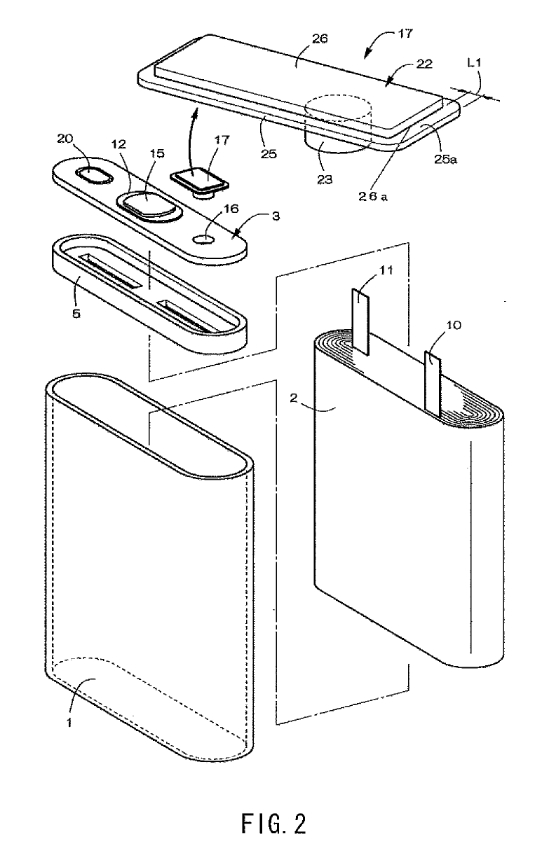

Hereinafter, an embodiment of the present invention will be described with reference to the drawings. FIG. 1 is a vertical sectional front view of a hermetically sealed battery according to this embodiment. FIG. 1 partially shows an upper portion of the hermetically sealed battery and also shows an enlarged view of the vicinity of a seal 17. FIG. 2 is an exploded perspective view of the hermetically sealed battery according to this embodiment.

The hermetically sealed battery shown in FIGS. 1 and 2 includes a battery can 1 containing an electrode body 2 and a nonaqueous electrolyte solution. The battery can 1 has the shape of a closed-bottom rectangular tube having in its upper surface a horizontally elongated opening extending in the right-to-left direction. The upper face of the opening of the battery can 1 is blocked and hermetically sealed with a horizontally elongated lid 3 extending in the right-to-left direction. Thus, a battery case 6 (FIG. 1) is formed. An insulator 5 made of plastic is disposed inside the lid 3.

An example of the battery can 1 has a width of 34 mm in the right-to-left direction, a height of 46 mm in the top-to-bottom direction, and a thickness of 4 mm in the front-to-rear direction.

In FIG. 1, a liquid injection hole 16 is blocked and sealed with the seal (sealing stopper) 17. The liquid injection hole 16 is sealed with the seal 17 by welding the seal 17 to a portion around the liquid injection hole 16 after injecting the electrolyte solution into the battery case 6 through the liquid injection hole 16 provided in the battery case 6.

As shown in FIGS. 1 and 2, the seal 17 has a quadrangular plate-shaped head section 22 that is welded to the portion around the liquid injection hole 16, which is the upper surface of the lid 3, and a column-shaped shaft section 23 that projects downward from a position slightly right of the center of a lower surface 22a (FIG. 1) of the head section 22.

In FIG. 1, the shaft section 23 of the seal 17 is inserted in the liquid injection hole 16 in a press-fitted state. The shaft section 23 may fit within the liquid injection hole 16 as shown in FIG. 1, but may also project through the liquid injection hole 16.

The head section 22 of the seal 17 is formed of a metal body in which an aluminum layer 25 formed of aluminum or an aluminum alloy and a nickel layer 26, which is the dissimilar metal layer formed of a metal different from aluminum or an alloy of the metal, are joined one on top of the other. The shaft section 23 is formed integrally with the aluminum layer 25. The aluminum layer 25 is disposed on the battery case 6 side.

The nickel layer 26 may also be replaced by a layer of a metal other than nickel, and for example, stainless steel or copper can be used as such a metal. Moreover, one or more metal layers may also be disposed between the aluminum layer 25 and the nickel layer 26.

For example, the seal 17 is produced in the following manner. First, a plate material made of aluminum or an aluminum alloy and a plate material made of nickel or a nickel alloy are laid one on top of the other, and in this state, these plate materials are pressure-bonded to each other by hot rolling, forge welding, or the like. Thus, a clad plate in which the aluminum layer 25 and the nickel layer 26 are joined one on top of the other can be produced.

Then, a quadrangular plate having substantially the same dimensions as the head section 22 of the seal 17 is cut from the above-described clad plate. The shaft section 23 is formed by forging the quadrangular plate using a pressing machine. At the same time, a peripheral edge portion 25a of the aluminum layer 25 in the head section 22 is made to protrude outward beyond a peripheral edge 26a of the nickel layer 26. The seal 17 is thus produced.

As shown in FIG. 2, in the head section 22 of the seal 17, the aluminum layer 25 has a larger size than the nickel layer 26. The peripheral edge portion 25a of the aluminum layer 25 protrudes outward beyond the peripheral edge 26a of the nickel layer 26 by a protruding dimension L1 of, for example, 0.4 mm.

The aluminum layer 25 in the head section 22 has a thickness of, for example, 0.15 mm, and the nickel layer 26 has a thickness of, for example, 0.2 mm. The shaft section 23 may have a thickness of, for example, about 0.6 mm or 1 mm in the top-to-bottom direction.

When the aluminum layer 25 is too thin, it is difficult to secure sufficient joining strength to the lead that is joined to the nickel layer 26, which is the dissimilar metal layer. On the other hand, when the aluminum layer 25 is too thick, the welding energy needs to be increased, resulting in poor weldability. Therefore, the aluminum layer 25 preferably has a thickness of 0.1 mm or more. Furthermore, the thickness of the aluminum layer 25 is preferably 1 mm or less, more preferably 0.5 mm or less, and even more preferably 0.2 mm or less.

When the nickel layer 26 is too thin, the nickel layer 26 is easily detached, and when too thick, the workability decreases and the resistance increases. Therefore, the nickel layer 26 preferably has a thickness of 0.01 mm or more, more preferably 0.05 mm or more, and even more preferably 0.08 mm or more. Furthermore, the thickness of the nickel layer 26 is preferably 0.5 mm or less and more preferably 0.2 mm or less. These preferred numerical ranges remain the same even when the nickel layer 26 is replaced by a different metal.

Desirably, the metal body in which the aluminum layer 25 and the nickel layer 26 are joined is produced by processing a clad plate as described above, in view of ease in processing. However, the clad plate is not a limitation, and the dissimilar metal layer of the metal body may also be formed by plating or vapor deposition.

The electrode body 2 shown in FIGS. 1 and 2 is produced by interposing a band-like separator between a band-like positive electrode and a band-like negative electrode, and in this state, spirally winding the band-like positive and negative electrodes. The separator is formed of, for example, a microporous thin film made of a polyethylene resin or the like.

The electrode body 2 has a flat shape as shown in FIG. 2 in the wound state. The positive electrode is produced by forming a positive electrode active material layer containing a positive electrode active material such as lithium cobalt oxide on both of the front and back surfaces of a band-like positive electrode collector. As shown in FIGS. 1 and 2, a sheet-like, positive electrode collecting lead 10 extends from the positive electrode collector.

The negative electrode is produced by forming a negative electrode active material layer containing a negative electrode active material such as graphite on both of the front and back surfaces of a band-like negative electrode collector. As shown in FIGS. 1 and 2, a sheet-like, negative electrode collecting lead 11 extends from the negative electrode collector.

The battery can 1 is molded by deep drawing a plate material of aluminum or an aluminum alloy. The lid 3 is molded by pressing a plate material of aluminum or an aluminum alloy, and an outer peripheral edge of the lid 3 is seam-welded to a peripheral edge of the opening of the battery can 1 using a YAG laser. The battery case 6 shown in FIG. 1 is thus formed. As shown in FIG. 1, a negative electrode terminal 15 is attached to and penetrates through the center of the lid 3 via an insulating packing 12 on the upper side and an insulating plate 13 on the lower side.

The liquid injection hole 16 having a circular shape when viewed from above is formed near the right edge of the lid 3 in the right-to-left direction so as to penetrate through the lid 3 in the top-to-bottom direction. The nonaqueous electrolyte solution is injected into the battery case 6 through the liquid injection hole 16. The nonaqueous electrolyte solution can be produced by, for example, dissolving LiPF₆ in a solvent in which ethylene carbonate and methyl ethyl carbonate are mixed.

After the injection of the electrolyte solution, the liquid injection hole 16 is blocked with the seal 17. A lead body 19 that is disposed on the inner surface of the lid 3 is connected to the lower end of the negative electrode terminal 15, the lead body 19 being a horizontally elongated sheet extending in the right-to-left direction. The lead body 19 extends away from the liquid injection hole 16 and is insulated from the lid 3 by the insulating plate 13. The negative electrode collecting lead 11 is welded to the lower surface of the lead body 19.

The positive electrode collecting lead 10 is welded to the back surface of the lid 3. Thus, the positive electrode collecting lead 10 is in communication with the lid 3 and the battery can 1, and the lid 3 and the battery can 1 are electrically charged to the potential of the positive electrode. A cleavage vent 20 is formed near an edge (near the left edge in FIG. 2) of the lid 3 in the right-to-left direction. When the internal pressure of the battery abnormally increases, the cleavage vent 20 cleaves and releases the internal pressure of the battery.

The aluminum layer 25 is welded to the lid 3 and thus forms a weld portion 29. Desirably, the weld portion 29 is formed only in the peripheral edge portion 25a of the aluminum layer 25 and kept from reaching the nickel layer 26. For this purpose, the peripheral edge portion 25a of the aluminum layer 25 preferably protrudes outside the seal 17 beyond the peripheral edge of the nickel layer 26 by a protruding dimension L1 (FIG. 2) of 0.1 mm or more. More preferably, the protruding dimension L1 is 0.2 mm or more and even more preferably 0.3 mm or more.

When the protruding dimension L1 is smaller than 0.1 mm, there is a risk that the weld portion 29 may reach the nickel layer 26. The larger the protruding dimension L1 is, the easier welding is. However, there is a risk that the peripheral edge portion 25a of the aluminum layer 25 may be too close to the negative electrode terminal 15, the insulating packing 12, and so on. Therefore, the upper limit value of the protruding dimension L1 is determined based on the distances from the insulating packing 12 and so on and other factors, and is preferably 1 mm or less. From the foregoing, a preferable range of the protruding dimension L1 can be, for example, from 0.3 to 0.5 mm.

Moreover, in the enlarged view of FIG. 1, the position of 29a (a boundary of the weld portion 29 on the nickel layer 26 side) is, for example, 0.2 mm to the outside of the position of 26a (the peripheral edge of the nickel layer 26). Preferably, the position of 29a is an average of 0.1 mm or more and more preferably an average of 0.2 mm or more to the outside of the position of 26a. The reason for this is that spattering of the metal due to spatters is reduced by forming the weld portion 29 away from the nickel layer 26, and the reliability of liquid injection is thus increased.

On the other hand, when the distance between the weld portion 29 and the nickel layer 26 is too large, the protruding dimension L1 (FIG. 2) also increases. Therefore, the distance between 26a and 29a also is preferably 1 mm or less in accordance with the preferable upper limit of the protruding dimension L1.

During assembly of the battery, the negative electrode terminal 15, the insulating packing 12, the insulating plate 13, and the lead body 19 are each attached to the lid 3 beforehand as described above. Then, after the electrode body 2 and the insulator 5 are contained in the battery can 1, the negative electrode collecting lead 11 and the positive electrode collecting lead 10 are welded to the lead body 19 and the lid 3, respectively, in the above-described manner. Subsequently, after the lid 3 is seam-welded to the peripheral edge of the opening of the battery can 1, a vacuum is created in the battery can 1, and the nonaqueous electrolyte solution is injected through the liquid injection hole 16.

After the completion of injection of the electrolyte solution, the peripheral edge portion 25a of the aluminum layer 25 of the seal 17 is welded to the lid 3 of the battery case 6, as shown in FIG. 1. Here, the peripheral edge portion 25a of the aluminum layer 25 is welded in a state in which the head section 22 is fixed by fitting the shaft section 23 into the liquid injection hole 16.

In this welding, for example, the outermost peripheral edge of the aluminum layer 25 is taken as the center line, and welding is performed along this center line using a YAG laser welder. Welding conditions can be, for example, an optical fiber (SI) diameter of 0.6 mm and a diameter of the laser beam emitted from an emitting unit of 0.45 mm.

The removal strength of the shaft section 23 after the shaft section 23 is inserted into the liquid injection hole 16 and before the laser welding is preferably 49 mN or more. This is because the reliability of hermetically sealing of the liquid injection hole 16 is further enhanced.

After the welding, the lower surface of the aluminum layer 25 is in contact with the upper surface of the lid 3 (see FIG. 1). Thus, the liquid injection hole 16 is blocked and sealed with the seal 17.

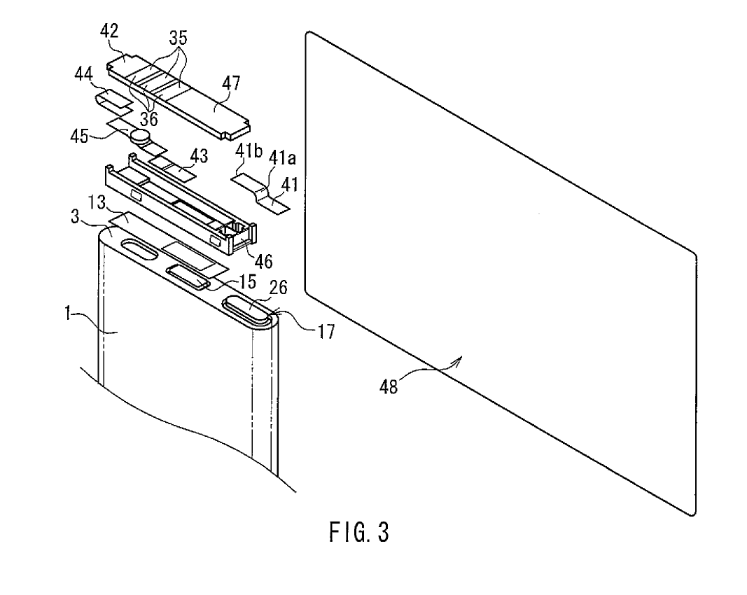

FIG. 3 is an exploded perspective view of an example of a battery pack according to this embodiment. As shown in FIG. 3, a positive electrode lead 41 that is connected to a protection circuit 42 in the form of a board is spot-welded to the upper surface of the nickel layer 26 of the seal 17 by resistance welding, laser welding, or the like. On the other hand, a negative electrode lead 43 that is connected to a PTC (Positive Temperature Coefficient) element 45 is spot-welded to the upper surface of the negative electrode terminal 15 by resistance welding, laser welding, or the like. Moreover, a retaining member 46 made of resin is disposed between the negative electrode lead 43 and the lid 3.

The positive electrode lead 41 is formed of, for example, a clad material having a layer of nickel or a nickel alloy and is welded to the seal 17 with the nickel surface being in contact with the nickel layer 26 of the seal 17.

The positive electrode lead 41 and the negative electrode lead 43 may each have the shape of a flat plate, or may be bent into an L-shape, a U-shape, a rectangular U-shape, or the like.

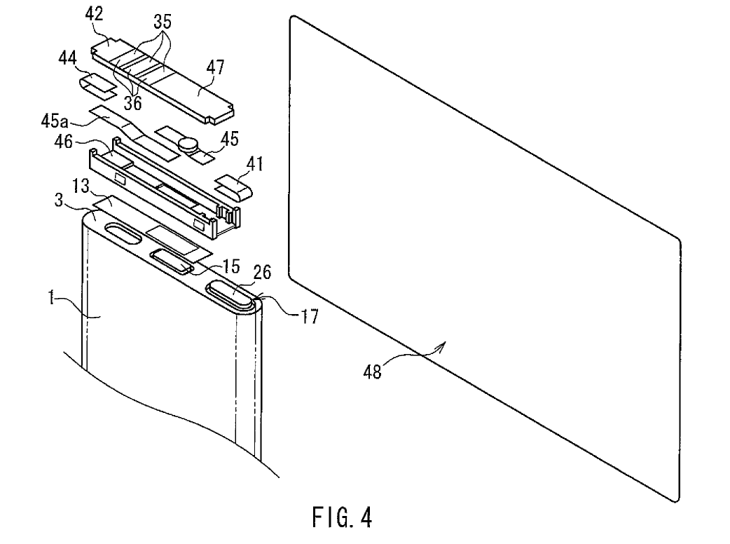

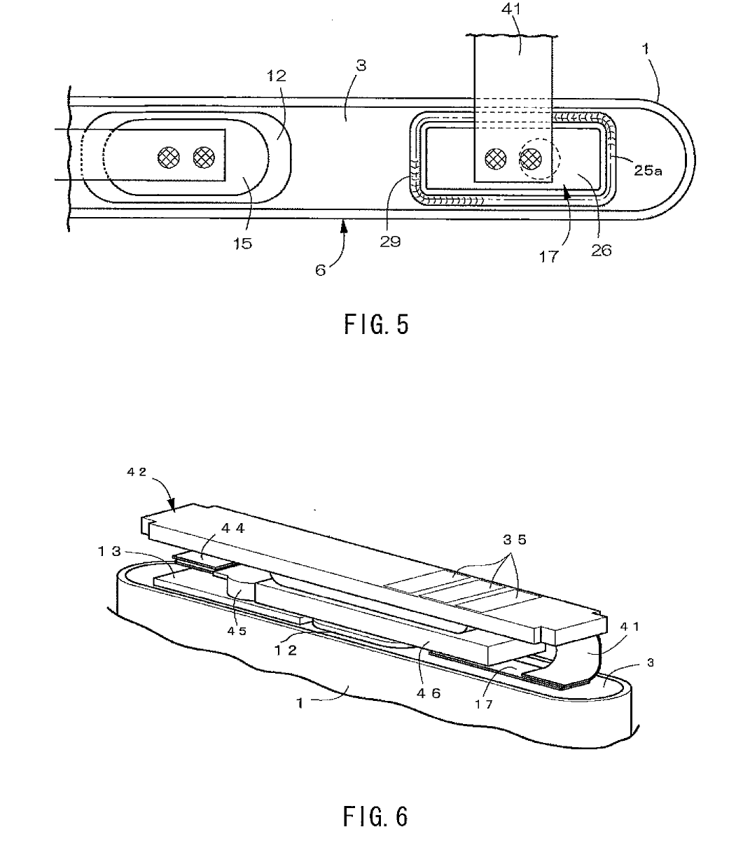

In order to secure the space retaining accuracy of the protection circuit 42, it is desirable that the positive electrode lead 41 extends toward the negative electrode terminal 15 while having an upwardly bent portion (FIG. 3), has a portion that extends in the thickness direction of the battery and is bent over (FIGS. 5 and 6), or has a portion that extends away from the negative electrode terminal 15 and is bent over (FIG. 4).

In view of the ease of manufacture, it is more desirable that the positive electrode lead 41 extends toward the negative electrode terminal 15. The protection circuit 42 and the negative electrode terminal 15 can be prevented from making contact with each other by forming an upwardly bent portion 41a in the middle of the positive electrode lead 41.

Desirably, the upwardly bent portion 41a is formed on the seal 17 or positioned within 5 mm from an end of the seal 17. The reason for this is that the positioning accuracy of the protection circuit 42 is likely to decrease when the upwardly bent portion 41a is further away from the seal 17.

Moreover, the distance from the upwardly bent portion of the positive electrode lead 41 to a front end 41b of the lead 41 is desirably within 5 mm. Note that when the bent portion is not on the seal 17, the distance from the seal to the front end 41b of the lead 41 is desirably within 5 mm. The reason for this is that, when the distance from the bent portion to the front end 41b of the lead 41 is 10 mm, the stability of various components is poor and defects that occur during resin molding increase as compared with the case (0 mm) where the lead 41 is upwardly bent on the seal 17 or from an edge portion thereof.

FIG. 4 is an exploded perspective view of another example of the battery pack according to this embodiment. The positive electrode lead 41 is bent into an L-shape in FIG. 3, whereas it is bent into a U-shape in FIG. 4. For example, the positive electrode lead 41 is made of nickel and has a thickness of 0.1 mm and a width of 3 mm.

An exemplary method for welding the positive electrode lead 41 onto the nickel layer 26 of the seal 17 is to weld the positive electrode lead 41 with a resistance welder (MICRO DENSHI MIRO-3002) using electrodes having a diameter of 1.5 mm under the following conditions: voltage (VOLT1)=5.0 V, pulse duration (WELD 1−T)=1.5 msec, voltage (VOLT2)=10.0 V, pulse duration (WELD 2−T)=2.5 msec, pulse number (WELD−T)=1, and welding pressure=9.8 N. This also applies to the battery pack in FIG. 3.

The positive electrode lead 41 Joined to the seal 17 is upwardly bent from the edge portion of the seal 17 formed of the clad material, and an upper portion of the lead 41 is joined to the protection circuit 42. The distance from the upwardly bent portion of the positive lead 41 to the front end of the lead 41 is 3 mm.

Furthermore, a lead 44 extending from the opposite side of the protection circuit 42 is joined to the negative electrode terminal 15 via a negative electrode lead 45a and the PTC element 45. Moreover, the retaining member 46 made of resin is disposed between the negative electrode lead 45a and the lid 3.

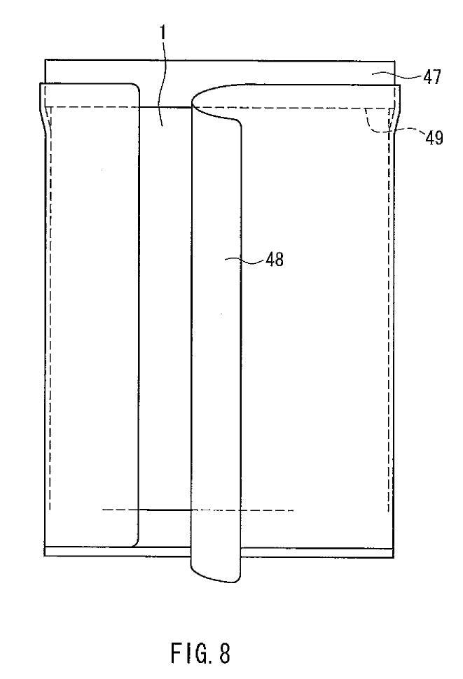

In FIGS. 3 and 4, the protection circuit 42 is covered with a resin portion 47 formed from a polyamide resin. As will be described later using FIG. 8, a boundary portion 49 (FIG. 8) between the hermetically sealed battery and the resin portion 47 is covered with a label 48.

Note that in FIGS. 3 and 4, the resin portion 47 is illustrated in such a manner that only one of the exterior surfaces of the protection circuit 42 is covered with the resin portion 47. The resin portion 47 may also be charged into a gap between the protection circuit 47 and the lid 3 so that the gap is completely filled up with the resin portion 47. Moreover, the resin portion 47 has windows 36 that are formed in the same positions as external connection terminals 35 provided on the protection circuit 42. Even when the polyamide resin is replaced by a polyurethane resin, the resin portion 47 provides the same effects.

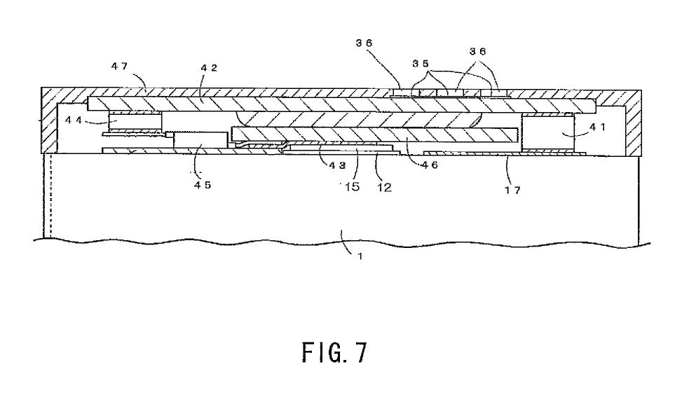

FIG. 5 is a plan view showing another embodiment of the state in which the seal 17 and the lead 41 are connected to each other. FIG. 6 shows a state in which various components have been attached from the state of FIG. 5. FIG. 7 shows a vertical sectional front view of an example of the completed battery pack.

In FIG. 5, the positive electrode lead 41 is joined to the nickel layer 26 of the seal 17. The lead 41 extends in the thickness direction of the battery case 6. The lead 41 shown in FIG. 5 has the shape of a flat plate, but in the state of FIG. 6, the lead 41 is bent into a U-shape. In the example of FIG. 7, the lead 41 bent into the U-shape is joined to the protection circuit 42.

FIG. 7 shows how the protection circuit 42 is covered with the resin portion 47. In FIG. 7, for easy understanding of the internal structure, the resin portion 47 is not shown in the space under the protection circuit 42. However, at least a portion of the seal 17 to which the lead 41 is welded is covered with resin. This also applies to the battery packs in FIGS. 3 and 4.

FIG. 8 is a diagram showing how the battery can 1 is covered with the label 48. The boundary portion 49 between the hermetically sealed battery and the resin portion 47 is covered with the label 48. Thus, the battery can 1 can be reliably covered with the label 48, and this is advantageous for improving the insulation quality.

With the above-described battery pack according to this embodiment, an electronic apparatus can be produced by, for example, installing the battery pack in a mobile telephone having a thickness of 15 mm.

Note that in the above-described embodiment, the shaft section 23 (FIGS. 1 and 2) of the seal 17 may also be formed of synthetic resin such as synthetic rubber. In this case, the shaft section 23 of the seal 17 is fixed to the lower surface 22a of the head section 22 with an adhesive or the like. The shaft section 23 of the seal 17 may also be inserted into the liquid injection hole 16 in a state in which the shaft section 23 has some play.

Moreover, the shaft section 23 may also be omitted, and the seal 17 may be formed only of the head section 22. Even in this case, the peripheral edge portion 25a of the aluminum layer 25 protrudes outside the seal 17 beyond the peripheral edge of the nickel layer 26.

The liquid injection hole 16 and the seal 17 are not necessarily required to be provided in the lid 3 and can be provided in any part of the battery case 6. For example, the liquid injection hole 16 and the seal 17 may also be provided in the bottom surface or a side surface of the battery can 1.

The seal 17 may also be formed of a clad plate in which the aluminum layer 25 is joined to, for example, a metal layer made of stainless steel, a stainless alloy, or the like instead of the nickel layer 26. The battery can 1 and the lid 3 may also be produced from a clad body at least the exterior side of which is formed of a layer of aluminum or an aluminum alloy.

Hereinafter, this embodiment will be more specifically described with reference to the results of experiments. Various samples were produced, and the joining strength between the positive electrode lead 41 and the seal 17 of the samples was measured. Specifically, the positive lead 41 and the main body of the battery were fixed with chucks and vertically pulled at a pulling speed of 3 mm/min to measure the joining strength. An Autograph (manufactured by Shimadzu Corporation: AGS-500G) was used as a measuring apparatus.

### Experiment 1

A positive electrode lead 41 made of nickel and having a thickness of 0.1 mm and a width of 3 mm was welded to a nickel layer 26 in a head section 22 of a seal 17 with a resistance welder (MICRO DENSHI MIRO-3002) using electrodes having a diameter of 1.5 mm under the following conditions: voltage (VOLT1)=5.0 V, pulse duration (WELD 1−T)=1.5 msec, voltage (VOLT2)=10.0 V, pulse duration (WELD 2−T)=2.5 msec, pulse number (WELD−T)=1, and welding pressure=9.8 N.

The pull-off strength required for pulling off the lead 41 was 43 N, and so the joining strength was sufficient. Moreover, only the positive electrode lead 41 was detached, and the seal 17 remained joined while still maintaining the sealing ability.

In other words, it can be considered that in the configuration of Experiment 1, the joining strength between the lead 41 and the nickel layer 26 is less than the joining strength between the seal 17 and the portion around the liquid injection hole 16.

### Experiment 2

The same test as in Experiment 1 was performed except that a positive electrode lead 41 having a thickness of 0.15 mm and a width of 3 mm was used. The pull-off strength was 73 N, and only the positive electrode lead 41 was detached as in the case of the 0.1 mm thick lead in Experiment 1.

In other words, it can be considered that also in the configuration of Experiment 2, the joining strength between the lead 41 and the nickel layer 26 is less than the joining strength between the seal 17 and the portion around the liquid injection hole 16.

### Experiment 3

A clad plate formed of an aluminum layer 25 having a thickness of 0.02 mm and a nickel layer 26 having a thickness of 0.1 mm was cut into predetermined dimensions and used as the head section 22 of the seal 17. A rubber was bonded to the head section 22 and used as the shaft section 23.

The other conditions were the same as in Experiment 1, and the pull-off test was performed. The weld portion between the seal 17 and the battery case 6 was separated at 15 N, and as a result, an opening was formed in the battery.

In other words, it can be considered that in the configuration of Experiment 3, the joining strength between the lead 41 and the nickel layer 26 is greater than the joining strength between the seal 17 and the portion around the liquid injection hole 16.

### Experiment 4

A clad plate formed of an aluminum layer 25 having a thickness of 0.08 mm and a nickel layer 26 having a thickness of 0.1 mm was cut into predetermined dimensions and used as the head section 22 of the seal. The head section 22 was processed so that the protruding dimension L1 (FIG. 2) was 0.2 mm. A rubber was bonded to the head section 22 and used as the shaft section 23.

The other conditions were the same as in Experiment 1, and the pull-off test was performed. The pull-off strength was 43 N, and so the joining strength was sufficient. Moreover, only the positive electrode lead 41 was detached, and the seal remained joined while still maintaining the sealing ability.

### Experiment 5

A clad plate formed of an aluminum layer 25 having a thickness of 0.05 mm and a nickel layer 26 having a thickness of 0.1 mm was cut into predetermined dimensions and used as the head section 22 of the seal. The head section 22 was processed so that the protruding dimension L1 (FIG. 2) was 0.1 mm. A rubber was bonded to the head section 22 and used as the shaft section 23.

The other conditions were the same as in Experiment 1, and the pull-off test was performed. The pull-off strength was 42 N, and so the joining strength was sufficient. Moreover, only the positive electrode lead 41 was detached. The seal 17 remained joined while still maintaining the sealing ability at the rubber portion, but some parts of the aluminum layer 25 were detached.

### Experiment 6

A battery pack as shown in FIG. 3 was produced by joining a seal 17 and a lead 41 under the joining conditions of Experiment 1. This battery pack was dropped 100 times from a height of 1.5 m, but the seal 17 portion was hermetically sealed tightly.

### Experiment 7

A battery pack as shown in FIG. 4 was produced by joining a seal 17 and a lead 41 under the joining conditions of Experiment 1. This battery pack was dropped 100 times from a height of 1.5 m, but the seal 17 portion was hermetically sealed tightly.

### Experiment 8

A battery pack as shown in FIG. 5 was produced by joining a seal 17 and a lead 41 under the joining conditions of Experiment 1. This battery pack was dropped 100 times from a height of 1.5 m, but the seal 17 portion was hermetically sealed tightly.

### Experiment 9

A battery pack was produced by joining a seal 17 and a lead 41 under the joining conditions of Experiment 3. When this battery pack was dropped 100 times from a height of 1.5 m, the electrolyte solution seeped out. The battery was disassembled, and it was found that the seal portion was dislodged.

### Experiment 10

A battery pack was produced by joining a seal 17 and a lead 41 under the joining conditions of Experiment 3. However, the label was not attached. When this battery pack was dropped 100 times from a height of 1.5 m, a liquid leaked out. The battery was disassembled, and it was found that the seal 17 portion was dislodged.

### Experiment 11

A battery pack as shown in FIG. 4 was produced by joining a seal 17 and a lead 41 under the joining conditions of Experiment 3. However, the label was not attached, and also the resin was not charged around the seal 17.

When this battery pack was dropped 100 times from a height of 1.5 m, a liquid flew out from the battery in an early stage. The battery was disassembled, and it was found that the seal 17 portion was dislodged.

### Experiment 12

A battery pack as shown in FIG. 4 was produced under the joining conditions of Experiment 1. This battery pack was installed to the back surface of a mobile telephone having a thickness of 15 mm, and then the mobile telephone was dropped 100 times from a height of 1.5 m. However, the seal portion was hermetically sealed tightly.

### Experiment 13

A battery pack as shown in FIG. 4 was produced under the joining conditions of Experiment 3. This battery pack was installed in a mobile telephone having a thickness of 15 mm and fixed thereto with a tape. After that, when the mobile telephone was dropped 100 times from a height of 1.5 m, a liquid seeped out. The battery was disassembled, and it was found that the seal portion was dislodged.

According to the foregoing experimental results, it can be said that a configuration in which the joining strength between the lead 41 and the nickel layer 26 is less than the joining strength between the seal 17 and the portion around the liquid injection hole 16 can prevent liquid leakage due to dislodgement of the seal 17 when an external force is applied to the lead 41.

The battery pack of the present invention can be used in various electronic apparatuses; for example, as a power supply of small size apparatuses such as notebook personal computers, pen-based personal computers, pocket personal computers, notebook word processors, pocket word processors, electronic book players, mobile telephones, cordless handsets, pagers, handy terminals, portable copiers, electronic organizers, electronic desk calculators, liquid crystal display televisions, electric shavers, power tools, electronic translators, car telephones, transceivers, voice input apparatuses, memory cards, backup power supplies, tape recorders, radios, headphone stereos, portable printers, hand-held cleaners, portable CD players, video movies, and navigation systems or as a power supply, an auxiliary power supply, or a backup power supply of large and medium size apparatuses such as refrigerators, air conditioners, televisions, stereos, water heaters, microwave ovens with oven function, dishwashers, washing machines, driers, game apparatuses, lighting apparatuses, toys, sensor apparatuses, load conditioners, medical apparatuses, cars, electric cars, golf carts, electric carts, security systems, and electric power storage systems.

Moreover, in addition to consumer applications, the battery pack of the present invention can also be used in space applications. Especially when the battery pack is used in small-size portable apparatuses, the effect of increasing the capacity is enhanced. Therefore, the battery pack is desirably used in portable apparatuses weighing 3 kg or less and more desirably portable apparatuses weighing 1 kg or less. The reason for this is that a battery pack employing the structure of the present invention can be of a more compact design because electrode portions can be concentrated in a single surface of the battery and the battery pack also has excellent reliability, that is, the battery pack is, for example, resistant to liquid leakage even when receiving an impact due to dropping or the like.

The lower limit of the weight of the portable apparatuses is not particularly limited. However, in order to achieve a certain degree of effect, the lower limit is desirably approximately the same as the weight of the battery, for example, 10 g or more.

The apparatuses desirably have a thickness of 30 mm or less, more desirably 20 mm or less, and even more desirably 15 mm or less. The reason for this is that the thinner the apparatuses are, the more likely the influence of expansion of the battery is to appear on the surface of the apparatuses. In this case, even when a slight external force is applied to the seal due to expansion or impact, the structure of the present invention makes damage to the electronic apparatuses and the portable apparatuses due to liquid leakage unlikely to occur, because the Joining strengths are balanced. Moreover, in order to secure sufficient capacity, the apparatuses desirably have a certain degree of thickness, and the thickness is desirably 2 mm or more.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A hermetically sealed battery comprising a liquid injection hole provided in a battery case and a seal that blocks the liquid injection hole, the liquid injection hole being sealed with the seal by welding the seal to a portion around the liquid injection hole in a state in which an electrolyte solution is injected into the battery case,
wherein the seal is formed of a metal body in which an aluminum layer formed of aluminum or an aluminum alloy and a dissimilar metal layer formed of a metal different from aluminum or an alloy of the metal are joined one on top of the other;
a lead that is connected to a PTC element or a protection circuit is joined to the metal body; and
the joining strength between the lead and the metal body is less than the joining strength between the seal and the portion around the liquid injection hole.

2. The hermetically sealed battery according to claim 1, wherein the seal is a positive electrode terminal.

3. The hermetically sealed battery according to claim 1,
wherein the aluminum layer of the metal body is disposed on the battery case side, and a peripheral edge portion of the aluminum layer protrudes outside the seal beyond a peripheral edge of the dissimilar metal layer; and
the peripheral edge portion of the aluminum layer is welded to the portion around the liquid injection hole.

4. The hermetically sealed battery according to claim 1,
wherein the seal has a head section that is welded to the portion around the liquid injection hole and a shaft section that projects downward from a lower surface of the head section;
the shaft section of the seal is inserted in the liquid injection hole; and
the head section of the seal is formed of the metal body in which the dissimilar metal layer is joined to the upper side of the aluminum layer.

5. The hermetically sealed battery according to claim 4, wherein the shaft section of the seal is formed integrally with the aluminum layer in the head section.

6. The hermetically sealed battery according to claim 3, wherein the peripheral edge portion of the aluminum layer protrudes outside the seal beyond the peripheral edge of the dissimilar metal layer by a protruding dimension of 0.1 mm or more.

7. The hermetically sealed battery according to claim 1, wherein an exterior side of the battery case is formed of aluminum or an aluminum alloy.

8. The hermetically sealed battery according to claim 3, wherein the peripheral edge portion of the aluminum layer is welded to the portion around the liquid injection hole using a laser.

9. A battery pack provided with the hermetically sealed battery according to claim 1,
wherein the lead is joined to a positive electrode terminal and a protection circuit; and
a second lead is joined to the opposite side of the protection circuit from a portion joined to the lead, the second lead being joined to a negative electrode terminal via a PTC element.

10. The battery pack according to claim 9, wherein the lead extends toward the negative electrode terminal while having an upwardly bent portion, has a portion that extends in a thickness direction of the hermetically sealed battery and is bent over, or has a portion that extends away from the negative electrode terminal and is bent over.

11. The battery pack according to claim 9, wherein the lead has the upwardly bent portion at a position on the positive electrode terminal or within 5 mm from an end of the positive electrode terminal.

12. The battery pack according to claim 9,
wherein the protection circuit is positioned above the negative electrode terminal;
the second lead extends away from the positive electrode terminal or has a portion that extends in a thickness direction of the hermetically sealed battery and is bent over; and
an insulating portion made of resin is provided between the protection circuit and the negative electrode terminal positioned under the protection circuit.

13. The battery pack according to claim 9, wherein the seal is covered with resin to form a resin portion, and a boundary portion between the hermetically sealed battery and the resin portion is covered with a label.

14. An electronic apparatus equipped with a battery pack provided with a hermetically sealed battery,
wherein the hermetically sealed battery comprises a liquid injection hole provided in a battery case and a seal that blocks the liquid injection hole, the liquid injection hole is sealed with the seal by welding the seal to a portion around the liquid injection hole in a state in which an electrolyte solution is injected into the battery case, and
wherein the seal is formed of a metal body in which an aluminum layer formed of aluminum or an aluminum alloy and a dissimilar metal layer formed of a metal different from aluminum or an alloy of the metal are joined one on top of the other;
a lead connected to a PTC element or a protection circuit is joined to the metal body; and
the joining strength between the lead and the metal body is less than the joining strength between the seal and the portion around the liquid injection hole.
